(19) United States
(12) Patent Application Publication
(10) Pub. No.: US 2002/0116531 A1
(43) Pub. Date: Aug. 22, 2002

(54) Applying anonymous personalization to web-based customer interactions

(75) Inventor: Heng Chu, Raleigh, NC (US)

Correspondence Address: Jeanine S. Ray-Yarletts, IBM Corporation T81/503, P.O. Box 12195, Research Triangle Park, NC, 27709, US

(73) Assignee: International Business Machines Corporation, Armonk, NY (US)

(21) Appl. No.: 09/790,085

(22) Filed: Feb. 21, 2001

(51) Int. Cl. G06F 15/16

(52) U.S. Cl. 709/246; 709/206

(57) ABSTRACT

A method, system, computer program product, and method of doing business by improving an end-user's interactions with Internet-based or Web-based customer service programs by applying anonymous personalization techniques. A case number or other case identifier is automatically assigned, and is used to associate information from related requests. Service agents are therefore able to automatically and efficiently obtain information about the related requests, and the user no longer has to repeatedly provide identifying information about himself, the problem for which he is requesting assistance, his hardware and software configuration, and so forth. No assumption is made about a client device's ability to support cookies or the use of consistent, identifiable sources address information in incoming request message headers. The user is not required to log in or otherwise explicitly identify himself. Several different techniques may be used to convey the case numbers used by the present invention throughout a series of related requests, including cookies, Uniform Resource Locator (URL) rewriting, hidden fields, and special URLs (which may be used, inter alia, to implicitly denote a case number).

### BACKGROUND OF THE INVENTION

1. Field of the Invention

The present invention relates to a computer system, and deals more particularly with a method, system, computer program product, and method of doing business by improving an end-user's interactions with Web-based customer service programs.

2. Description of the Related Art

Internet-based or Web-based customer interaction systems (hereinafter, “WCI systems”) provide instant service to customers needing assistance while browsing the Web. Typically, a service agent representative of an e-business company and a customer of that company interact with each other using one of several different communication mechanisms (or perhaps more than one mechanism). These mechanisms include instant messaging (e.g. chat sessions), e-mail message exchanges, collaborative or shared browsing, and telephone conversations (e.g. using a second telephone line, or Voice over IP technology to make use of a single telephone line).

When using instant messaging, a user (i.e. a customer) and a service agent exchange messages in real-time by typing those messages into special instant messaging sessions of the type which are known in the art. The user and service agent may send questions and answers to each other in a slower, less direct fashion by using e-mail. Telephone communications allow real-time communication, with the user and service agent discussing the problem at hand while the user is typically viewing some sort of pertinent information displayed on his computer. (The service agent may also be viewing this information on her own computer.) Collaborative or shared browsing, as used herein, refers to a technique whereby the user and the service agent simultaneously view the same Web pages, and interactions between the browsers of each person are linked. In this manner, the service agent can control what the user sees on his display device, and can lead the user through a particular navigation path as a type of “guided tour”. For example, the service agent may control the user's cursor, causing it to move to a particular location on a Web page, and then selecting an action from that Web page by clicking on a button or other graphical user interface (“GUI”) element. Because the user and service agent are viewing the same Web pages and the same shared interactions, the actions taken by the service agent on her computer are reflected on the display of the user's computer (and on the display of the service agent's computer as well). The shared browsing aspect of WCI systems is particularly well suited for applications which require filling out complex forms or navigating complex sequences of Web pages, due to the real-time guidance that can be provided.

Along with the increasing popularity of conducting business on the Web, Web shopping, on-line stock trading, and so forth, WCI systems are also becoming increasingly popular as a technique for handling customer relationships and customer interactions. The Cahners In-Stat Group, a high-technology market research firm, predicts that the market for WCI systems will reach $1.8 billion by 2004. (See “Web-Based Customer Interaction to Revolutionize Customer Response Management”, an Internet press release which may be found at location www.instat.com/pr/2000/ec0001 ms_pr.htm.)

Existing WCI systems focus on addressing each request individually. There are no techniques known to the inventor whereby related requests—such as multiple requests from a particular user, as he repeatedly deals with some problem—are automatically associated. Furthermore, the WCI systems do not attempt to personalize the Web pages delivered to a particular user based on his requests or his experiences with the WCI system. Personalization of Web content is becoming an increasingly popular technique for attracting and maintaining customers in the on-line world. Automated personalization techniques range from complex, mathematical analysis of a user's navigational habits to simply reflecting user preference information that is explicitly supplied by the user. As one example, shopping sites such as Amazon.com analyze a shopper's purchases and make suggestions for new items that shopper might be interested in purchasing. As another example, some on-line news services allow users to indicate their areas of interest, and then filter the news presented to that user accordingly. The absence of associations of multiple requests and personalization in WCI systems are disadvantages that may lead to a great deal of frustration for users as the user may be required to effectively “start over” with each additional request (especially when some amount of time passes between one series of interactions and another, in which case the user may be required to re-describe his problem to the service agent or perhaps to a different service agent each time he returns to the WCI system). For example, if the user is attempting to complete the “electronic paperwork” for refinancing a mortgage on-line, it may take several sessions before the user completes the entire set of required information, and he may need to contact a service agent through a WCI system multiple times throughout the process. As another example, a user may be diagnosing a problem with his computer hardware or software, and may need to use a WCI system to receive assistance from a service agent several times before the diagnosis is complete. In addition to repeatedly having to provide identifying information about himself, the user may also have to repeatedly describe the problem for which he is requesting assistance, his hardware and software configuration, and so forth.

There are a number of technological inhibitors which prevent existing WCI systems from associating related requests from a particular user (and from personalizing content for users) in an easy-to-use, reliable, and automated manner. These inhibitors will now be described.

Some WCI systems may require a user to register and log in, and will then associate related requests for information based on the provided log-in identifier. However, this process is cumbersome for users, in that an explicit act is required on the user's part. User frustration may even be increased when using this approach, as the user might encounter his difficulties during a navigation path for which he has not yet logged in; he is then typically required to stop, log in, and then start over and attempt to re-create the problem within the session where he is “recognized”—with the possibility of being unable to re-create the problem.

Other WCI systems may attempt to track a user's history using “cookies”. A “cookie” is a data object transported in variable-length fields within Hypertext Transfer Protocol (“HTTP”) request and response headers that is normally stored on the user's computer, either for the duration of a session (e.g. throughout a customer's interactions with the WCI system via a single browser instance) or permanently. A cookie stores certain data that a server application wants to remember about a particular client. This could include client identification, session parameters, user preferences, session state information, or almost anything else an application writer can think of to include. However, one can no longer rely on cookies as a means of maintaining application state information (such as the identity of the client device and/or user) across Web transactions. Certain client devices are incapable of storing cookies. These include wireless pervasive devices (such as Webphones, personal digital assistants or “PDAs”, and so forth), which typically access the Internet through a Wireless Application Protocol (“WAP”) gateway using the Wireless Session Protocol (“WSP”). WSP does not support cookies, and even if another protocol was used, many of these devices have severely constrained memory and storage capacity, and thus do not have sufficient capacity to store cookies. While it is possible for a wireless gateway product to store cookies on behalf of its wireless clients, this type of “cookie proxying” support is not ubiquitous. (For example, the IBM eNetwork Wireless Gateway provides cookie proxying, although the Nokia WAP gateway product does not.)

Furthermore, users are either turning on “cookie prompting” features on their devices (enabling them to accept cookies selectively, if at all) or completely disabling cookie support out of concerns for privacy since some advertising organizations have begun using cookies as a way of tracking users as they browse, and using this tracking information for aggregating personal data. This unsavory activity has triggered new European Union laws which will force browser manufacturers to provide more end-user control over cookies, and may mean that the default browser security configuration will disable cookies in the near future. The unsavory use of cookies is often associated with “Web bugs”, which are now finding their way outside of their use within Web pages displayed by a browser into other Internet-enabled applications, as exemplified by the recent threat of Microsoft Office documents containing these “Web bugs”. (A “Web bug” is a means of enabling information to be reported from the user's device to an application in the network, for example for tracking information about the user's session by including invisible miniature graphic images within a document. Unlike cookies, support for Web bugs cannot be turned off by the end user.)

WCI systems are unable to associate related requests from a particular user by relying on the source Internet Protocol (“IP”) address of incoming requests, and detecting and storing these addresses. This inability to distinguish a specific user based on source IP address is caused by several factors. For example, the increasing prevalence of Network Address Translators (“NATs”), firewalls, and transparent proxies/caches in networks renders “address:port” combinations useless as a unique identifier of a client device (and therefore of its user). NAT technology has been widely implemented by Internet Service Providers (“ISPs”) as a means of connecting the large number of home users to the Internet without using a larger number of registered addresses (which are a limited resource, and therefore expensive), and to protect the privacy of individual subscriber's IP addresses. ISPs also use Dynamic Host Configuration Protocol (“DHCP”) or Point-to-Point Protocol (“PPP”) to dynamically assign private addresses to customer equipment, and use transparent proxies (for such things as the Web, news, and multi-media information) as a way of minimizing backbone traffic. NAT, DHCP, and PPP provide many benefits by enabling always-connected home networks (such as those based on cable modem or Asymmetric Digital Subscriber Loop, or “ADSL”, technology), reducing the cost of the provider backbones, and helping to restrain hackers from taking advantage of open ports to end-user equipment, but these steps resulted in the loss of a unique IP address for the user. In fact, one goal of NAT is to conceal the end-user host's true identity by substituting some constant IP address for the host's true identity. NAT technology is becoming increasingly prevalent, as it is commonly used in a device that connects a multiplicity of mobile clients to the Internet. (Examples of such devices include Local Area Network, or “LAN”, routers; smart hubs; and modems for home networks, such as the Integrated Services Digital Network, or “ISDN”, modem marketed by the 3Com Corporation.)

Multiple clients can therefore have the same IP address and port combination. Furthermore, a given client's address and port values change when multiple Transaction Control Protocol (“TCP”) sessions are used to deliver a Web page composed of multiple elements. HTTP 1.1's long-lived TCP sessions (which were expected to offer significant advantages over the single request/response, short-lived sessions of HTTP 1.0) are of little help in addressing this difficulty, since a proxy or cache server often converts HTTP 1.1 protocols to HTTP 1.0 (e.g. in order to affect the manner in which cached data is served), making the client IP addressing short-lived (as before), or uses an upstream HTTP 1.1 session for multiple downstream client requests.

The server used for a user's prior interactions with a WCI system may also vary over time, for example when a load-balancing host serves as a front-end for a cluster of back-end Web servers. In such cases, it may be beneficial to know which Web server was previously involved for this user's requests. However, the server IP address and port combination does not provide a unique identifier of the target service appearing in the “Host” field of the HTTP header. This is because the cluster of servers may be front-ended by a load-balancer (or perhaps by a reverse proxy) that provides a virtual IP address for the entire cluster. Or, when virtual domain hosting is used (such as when an ISP enables its subscribers to store their own Web pages on its equipment, yet be addressed using an address allocated to the subscriber), multiple server domains sharing a single server platform are addressed by a single address and port combination.

Accordingly, what is needed is a technique which avoids these problems of the prior art, and which makes the user's experience with a WCI system more enjoyable and more productive.

### SUMMARY OF THE INVENTION

An object of the present invention is to provide a technique for improving Web-based customer interaction systems.

Another object of the present invention is to provide these improvements by automatically associating related requests.

Yet another object of the present invention is to provide these improvements by personalizing Web pages with user-specific and/or problem-specific information.

A further object of the present invention is to provide these improvements without requiring the user to explicitly supply information for tracking his navigation path.

Still another object of the present invention is to provide these improvements without requiring the user's computing device to support cookies and/or Web bugs.

Yet another object of the present invention is to provide these improvements without relying on addressing information from incoming request messages.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides a method, system, and computer program product for improving Web-based user interaction systems. In one embodiment, this technique comprises: assigning a unique case identifier to an interaction, wherein the interaction comprises transmission of a series of related messages; annotating each of the related messages, except a first incoming one thereof, with information reflecting the assigned case identifier; and transmitting at least one of the annotated messages to a user. The case identifier may be, for example, a case number.

The annotation process may further comprise inserting the case identifier into a Uniform Resource Locator (“URL”) in an object requested by a selected one of the related messages, thereby creating an annotated object, which is then transmitted as the annotated message. In this case, the case identifier may be inserted as a parameter of the URL, or perhaps within a domain name portion of the URL or within a path name portion of the URL.

Selected objects which are referenced within a document that is to be transmitted may be annotated. An annotated message may be a request for a Web page sent from the user's computer. Or, an annotated message may perhaps be a response that serves a Web page to the user's computer. In this latter case, a subsequent one of the related messages may be a request for information referenced by the Web page, or perhaps a request for information selected from the Web page by the user.

One or more cookies may be inserted into selected ones of the related messages, and transmitted to the user's browser. In this case, the technique preferably further comprises automatically returning these cookies from the browser as the annotation of subsequent related messages sent by the browser.

One or more hidden fields may be inserted into selected ones of the related messages, and transmitted to the user's computer. In this case, the technique preferably further comprises automatically returning these hidden fields from the computer as the annotation of subsequent related messages sent by the computer.

A special Uniform Resource Locator may be provided in a related message as an annotation, in which case the technique preferably further comprises sending a request for the special URL in a subsequent related message, wherein the special URL is automatically included as the annotation of the subsequent message because of receiving this special URL in the transmitted message. The special URL may identify content that is personalized in a number of different ways, such as (1) with information pertaining to the user, (2) with information pertaining to a problem scenario of the user, or (3) with information pertaining to a navigational sequence of the user.

The technique preferably further comprises receiving a subsequent message from the user, wherein this subsequent message automatically contains the annotation from the transmitted message (or perhaps an identifiable variant thereof).

In another aspect, the present invention provides a method, system, and computer program product for providing an improved user interaction system in a networking environment, comprising: assigning a case identifier to an interaction which comprises transmission of a series of related messages; providing the assigned case identifier when transmitting each of the related messages that is directed to a user to which the interaction pertains; and automatically returning the assigned case identifier on each of the related messages that is sent from the user, except a first incoming one thereof, thereby providing an on-going automatic association among the series of related messages.

The present invention may also be used advantageously in methods of doing business, for example in Web shopping applications or in other e-business applications having operations or transactions for which programmatically associating related requests proves advantageous.

The present invention will now be described with reference to the following drawings, in which like reference numbers denote the same element throughout.

### BRIEF DESCRIPTION OF THE DRAWINGS

FIG. 1 is a block diagram of a computer workstation environment in which the present invention may be practiced;

FIG. 2 is a diagram of a networked computing environment in which the present invention may be practiced;

FIG .3 provides a flowchart depicting logic which may be used to implement preferred embodiments of the present invention; and

FIG. 4 illustrates an example of Web pages that may be displayed to a user of the present invention.

### DESCRIPTION OF THE PREFERRED EMBODIMENTS

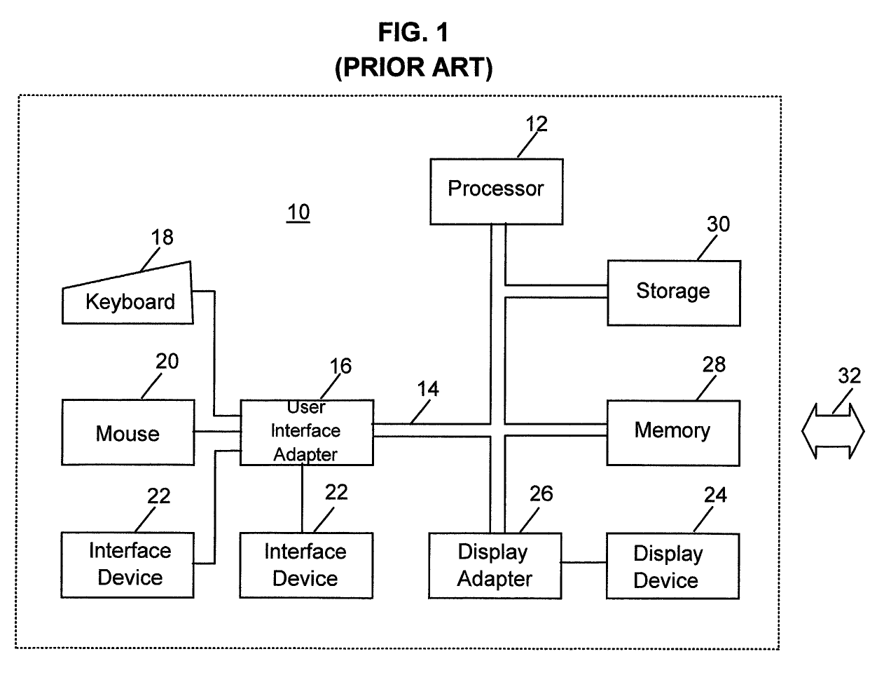

FIG. 1 illustrates a representative workstation hardware environment in which the present invention may be practiced. The environment of FIG. 1 comprises a representative computer or intelligent workstation 10, such as a personal computer, including related peripheral devices. The workstation 10 includes a microprocessor 12 and a bus 14 employed to connect and enable communication between the microprocessor 12 and the components of the workstation 10 in accordance with known techniques. The workstation 10 typically includes a user interface adapter 16, which connects the microprocessor 12 via the bus 14 to one or more interface devices, such as a keyboard 18, mouse 20, and/or other interface devices 22, which can be any user interface device such as a touch-sensitive screen, digitized entry pad, etc. The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The workstation 10 may communicate with other computers or networks of computers, for example via a communications channel or modem 32. Alternatively, the workstation 10 may communicate using a wireless interface at 32, such as a CDPD (cellular digital packet data) card. The workstation 10 may be associated with such other computers in a local area network (LAN) or a wide area network (WAN), or the workstation 10 can be a client in a client/server arrangement with another computer, etc. All of these configurations, as well as the appropriate communications hardware and software, are known in the art.

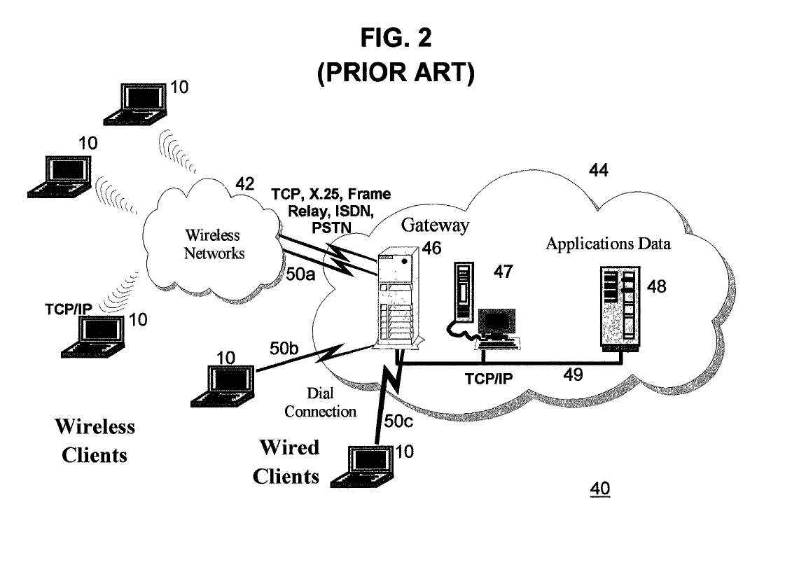

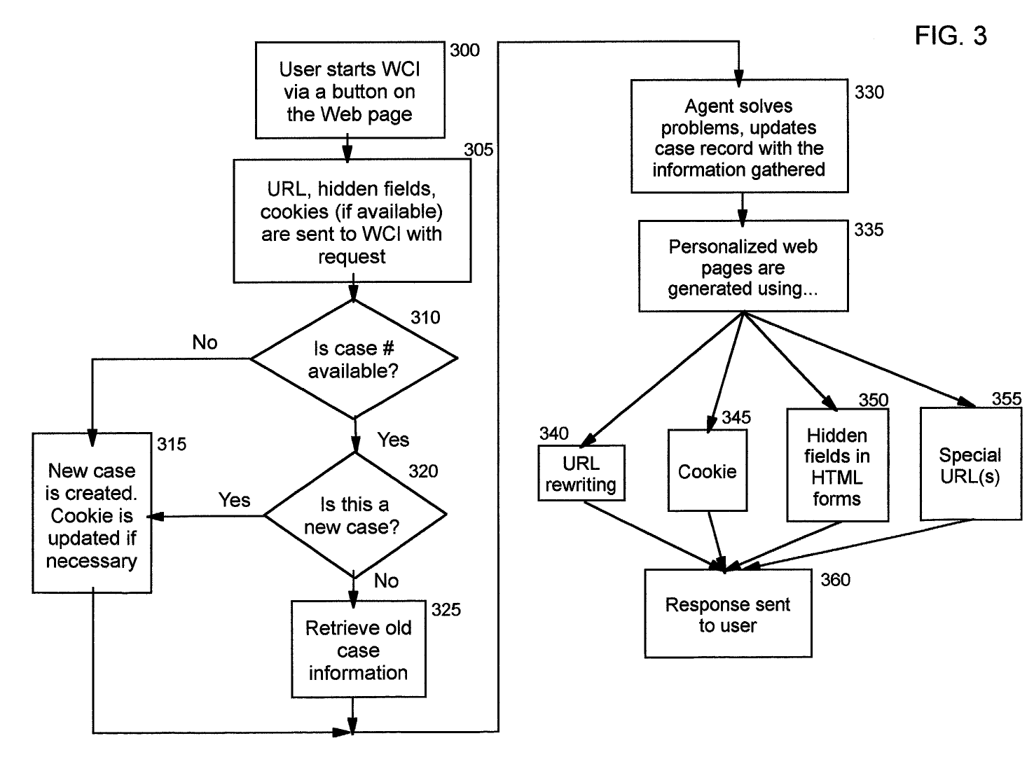

FIG. 2 illustrates a data processing network 40 in which the present invention may be practiced. The data processing network 40 may include a plurality of individual networks, such as wireless network 42 and network 44, each of which may include a plurality of individual workstations 10. Additionally, as those skilled in the art will appreciate, one or more LANs may be included (not shown), where a LAN may comprise a plurality of intelligent workstations coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 is preferably coupled to another network 42 by means of a communications link 50a. The gateway 46 may also be directly or indirectly coupled to one or more workstations 10 using a communications link 50b, 50c. The gateway computer 46 may also be coupled 49 to a storage device (such as data repository 48). The gateway computer 46 may be implemented utilizing an Enterprise Systems Architecture/370 available from the International Business Machines Corporation (“IBM”), or an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 46 may be located a great geographic distance from the network 42, and similarly, the workstations 10 may be located a substantial distance from the networks 42 and 44. For example, the network 42 may be located in California, while the gateway 46 may be located in Texas, and one or more of the workstations 10 may be located in New York. The workstations 10 may connect to the wireless network 42 using TCP/IP over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The workstations 10 may alternatively connect directly to the gateway 46 using dial connections 50b or 50c. Furthermore, the wireless network 42 and network 44 may connect to one or more other networks (not shown), in an analogous manner to that depicted in FIG. 2.

Software programming code which embodies the present invention is typically accessed by the microprocessor 12 (e.g. of the server 47) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

A user of the present invention may connect his computer to a server using a wireline connection, or a wireless connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing and communication capabilities. The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

In preferred embodiments, the present invention is implemented as one or more modules of one or more computer software programs. Availability of a network connection is assumed. The server to which the user's computer connects may be functioning as a Web server, where that Web server provides services in response to requests from a client device connected through the Internet. Alternatively, the server may be in a corporate intranet or extranet of which the user's computer is a component, or in any other networking environment. The present invention operates independently of the communications protocol used to send messages or files between the client and server, although HTTP running on TCP/IP is used herein as an example when discussing these message flows. (References to use of HTTP messages herein are for purposes of illustration and not of limitation. Other similar protocols may be used alternatively, including but not limited to the Secure Hypertext Transfer Protocol “HTTPS”.)

The present invention provides advantageous features over existing WCI systems, by automatically assigning a “case number” or other case identifier and then using this case number to associate information from related requests. Using the present invention, service agents are therefore able to automatically and efficiently obtain information about these related requests. (In some instances, related requests are multiple requests from the same user about a particular transaction or operation, although this is for purposes of illustration and not of limitation.) This technique may save users from repeating similar questions over and over again, and will therefore greatly improve the user's productivity and satisfaction with the WCI system (and perhaps with an underlying product or service for which the WCI system provides user assistance). Furthermore, use of the present invention allows personalized Web pages to be pushed to the user's computer to address specific needs (as will be described below). These advantageous features are provided for “anonymous” users, i.e. the user's computer is not required to support cookies or Web bugs, and no reliance is made on having a consistent or identifiable address in the incoming requests from this client device. In addition, the present invention does not require registration or log-in procedures in order for a user's requests to be automatically associated and retrieved for subsequent use. Preferably, the techniques of the present invention will be implemented as modifications to existing WCI systems.

Reference is now made to FIG. 3, which provides a flowchart depicting logic which may be used to implement preferred embodiments of the present invention. Preferably, the user initiates a request for assistance (or equivalently, for other types of interactions) with a WCI system by clicking on a button or other GUI indicator which is displayed on a Web page (Block 300). (Other invocation techniques may be used as well, including but not limited to interpretation of a spoken command by voice activation software.) In response, an invocation request message is generated and sent to the WCI system, along with information for use with the present invention (Block 305). In preferred embodiments, this information comprises (1) the Uniform Resource Locator (URL) of the currently-viewed Web page and (2) all cookies, if any, that are related to this site. Note that this URL may identify a Web page having either static content or dynamic content. The pertinent cookies are located and sent in the request message using techniques which are well known in the art.

During continued interactions with the WCI system, additional request messages within the series of related requests are sent from the user's computer. (For purposes of discussion, it will be assumed that the series of related requests pertains to an on-going transaction with a particular user. This series of related requests is also referred to herein as a “case” or “case history”.) Similar information to that which has been described for the invocation request message of Block 305 (i.e. the URL of the currently-viewed page, and perhaps cookies) is also transmitted to the WCI system for these subsequent request messages. According to the present invention, information in a request message sent by the user's computer (other than the initial invocation message) is augmented with an identification of the user's case. (Preferably, the case identifying information is created by the WCI system and is assigned for the scope of a particular case, as discussed in more detail below with reference to Block 315.) The additional case identifying information may be contained within the target URL of the incoming message (e.g. in one or more parameters of that URL, or perhaps as part of the URL path or domain name when URL re-writing, as described below, is used). Or, the additional case identifying information may be contained in one or more cookies of the HTTP request header, or in hidden fields within the request message. Or it may be that the particular target URL itself is in some manner inherently indicative of the case number. Use of these techniques to identify an on-going case is described in more detail below. Furthermore, particular implementations may choose to transmit additional information beyond the case number in these request messages using the techniques disclosed herein. (As one example, a cookie or perhaps a URL parameter may be used to identify the service agent who has been working with this user on his case.) According to preferred embodiments, the assigned case identifying information will become part of all messages transmitted within the current transaction (except, of course, the first message, which is transmitted prior to the assignment). (Hereinafter, the case identifying information is referred to as a “case number”, although as stated earlier, there is no requirement that this information is in numeric form. Thus, use of the term “case number” herein is merely for ease of reference.) Request messages transmitted from the user's computer (hereinafter referred to as the client) to the server on which the WCI system is running thus carry this case number, and responses sent back to the user's computer also preferably carry this same case number. When a subsequent request message for the case arrives at the WCI system, the case number enables the system to automatically determine that this request is part of an on-going series of message exchanges. (In alternative embodiments, the case number may be transformed in a predictable manner during the series of message exchanges. For example, a sequence counter or other similar correlator, or perhaps a date and time stamp, may be reflected in the case number. In these alternative embodiments, the case number transmitted on each message will vary accordingly, and the logic that detects when a related message has arrived is also modified accordingly.) Upon receiving requests at the WCI system, and generating responses for transmission back to the client, the case number is recorded along with the information obtained by that particular WCI system in its normal course of operation (i.e. while logging problem reports, if the WCI system is adapted to problem determination and/or tracking; while storing partially-completed or incrementally-supplied information for completing an on-line mortgage application, if the WCI system is adapted to helping the user complete a complex sequence of financial forms; and so forth). The service agent may optionally be provided with the case number and may manually convey that case number while recording information about the user's interactions, and/or the case number may be automatically recorded along with information recorded by the service agent.

Several techniques for transmitting the case number between the user's computer and the WCI system may be used. These include cookies, URL rewriting, hidden fields, and special URLs. Upon receiving an incoming request at the WCI system (which may be an invocation request, or a subsequent request that is part of an on-going case), a test is made (Block 310) to see if a case number is available for this request. Preferably, the test that is performed is adapted to the particular technique that is in use by an implementation of the present invention for transmitting the case number. (However, it may happen that multiple techniques are in use, in which case the test is Block 310 is adapted accordingly. In addition, if an implementation wishes to transmit case numbers using cookies, it may be necessary to dynamically determine, for each client, whether cookie support is available; in this case, the test in Block 310 may include checking for a case number in an incoming cookie as well as checking for a case number that is supplied using one of the alternative techniques.)

If cookies are supported on the user's computer, then the case number may be sent between the client and server as a cookie. Block 310 therefore may check to see if a cookie containing a case number has arrived with the incoming request. (In some cases, it may be determined in advance that a user's computer does not support cookies, in which case this check is preferably omitted from Block 310.)

Or, “URL rewriting” may be used for exchanging case numbers between the client and server. URL rewriting is a way of ensuring that requests sent to the server will have the case number plugged into the URL. Web pages or other structured documents that are sent to the client machine often have hypertext links embedded in them. A hypertext link is an address the user can click on from the displayed page, which may cause a request for a different page or Web object to be sent to the server. By putting the case number into the address in that link, the server can extract this information from the header of the received requests and can therefore correlate the related requests. Processing by the WCI system's server is required for rewriting the URLs in outbound response messages. That is, before the server sends a Web page or other structured document to a client, the server will check to see if the Web page or document has URLs embedded in it. If so, the server adds the case number for this transaction into the URL syntax (e.g. as a parameter, or as part of the target address) before sending the page. When URL rewriting is employed in an implementation of the present invention, then Block 310 preferably checks the URL of the incoming request to see if it contains a case number.

Hidden fields provide another technique which may be used to transmit case numbers. Hidden fields may be represented, for example, as information encoded in a non-displayable tag value of a markup language document. Using this approach, a document encoded in a markup language such as the Hypertext Markup Language (“HTML”) or other similar notation might contain a tag such as “<case₁₃ number value=“12251955”>”, indicating that the case number is 12,251,955. When hidden fields are used in an implementation of the present invention, then Block 310 preferably checks the markup tags (or other type of hidden field) from the incoming request to see if an existing case number is found.

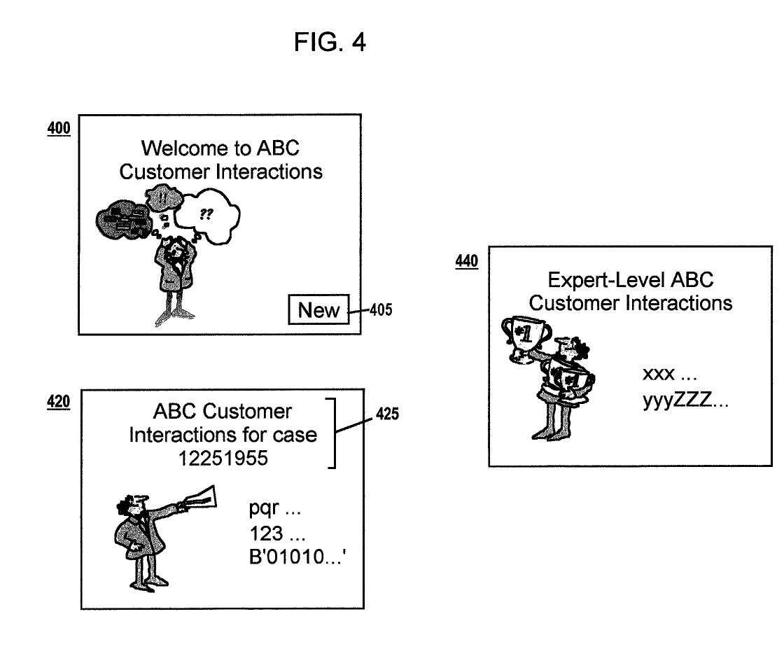

Special URLs may also be used to transmit case numbers. As described in more detail below (with reference to FIG. 4), special URLs enable identifying user-specific and/or problem-specific page content. For example, suppose the WCI system generates a URL such as “www.xyz12251955.pqr” during case number 12,251,955 by including the case number within the domain name portion of the URL. Preferably, the WCI system remembers its association of this URL with this case number; the relationship of an incoming request to this case number may then be inferred by arrival of a request for a page having this special URL.

A particular WCI system may be adapted to using one or more of the above-described techniques for transmitting case numbers. Preferably, if the WCI system transmits case numbers in cookies, then at least one other method is supported as well for use with those clients that either cannot or will not accept cookies.

If a case number is not available for an incoming request (i.e. the test in Block 310 has a negative result), then a new case number is created (Block 315). The case number may be computed using any suitable technique, and the particular manner of computation does not form part of the present invention. If cookies are being used to transmit case numbers, then a cookie that will be returned to the user's computer in a response message is also updated in Block 315 to reflect the new case number. Control then transfers to Block 330.

If a case number is available for the incoming request (i.e. the test in Block 310 has a positive result), then at Block 320 an optional test is performed to determine whether this request may still be considered as beginning a new case (i.e. a request message that is to be treated as unrelated to a prior series of message exchanges). Finding an existing case number, but determining that a new case number should be used anyway, may happen for a number of reasons. For example, the user may have stored a rewritten URL reference containing a case number as a bookmark, and may have then selected that URL after several days or weeks have passed. Or, the rewritten URL may have been obtained from a Web page that has been stored in a Web cache for a considerable period of time. A received case number may therefore have become stale or obsolete. As another example, the WCI system may periodically purge or archive stored information about user interactions, in which case the records which were to provide a history for this case number are no longer available. (Note that in situations of this type, the WCI system may optionally be augmented with means for automatically associating a closed or obsolete case number with a new case number. For example, an indication of the “old” case number may be maintained, and logic may be provided for detecting an incoming request with this case number; in response, a relationship may be automatically established with a new case number that is created for subsequent interactions with the user. Requests referring to the old case number may then be automatically redirected to a case history associated with the new case number.)

In alternative embodiments, a user may also explicitly mark the beginning of a new case. In these embodiments, at least one Web page of the WCI system is adapted to provide a “New Case” button. (Or, other similar indication means may be provided, such as a “New Case” function key, pull-down menu bar selection, etc.) Use of this user-initiated mark then causes a case number to be omitted from the next request message sent from the client device.

If the test in Block 320 has a positive result (i.e. this request pertains to a new case), then control transfers to Block 315 to create a new case number (as has been described above). Otherwise, when this is a request message for an existing case, processing continues at Block 325 which retrieves the previously-stored case history for this case number.

Control reaches Block 330 after a new case number has been assigned, or after the history for an on-going case has been retrieved. The service agent then solves the user's problem or otherwise interacts with the user in an application-specific manner. For example, the service agent may direct the user's navigation with a shared browsing session, or the service agent and user may exchange e-mail or talk by phone. The service agent also preferably updates the user's case records with the information gathered in this process, and stores the updated information in case it is needed subsequently for any purpose.

A personalized Web page is then generated at Block 335, using one (or more) of the techniques for communicating case numbers which has been described above (as indicated by Blocks 340, 345, 350, and 355). (The personalization comprises at least an identification of the user's case, and may in some implementations include additional user-specific and/or problem-specific information, as described below with reference to FIG. 4.) If using URL rewriting (Block 340), the personalized page includes references to the user's case number in embedded URLs (e.g. within a markup language document). If using cookies (Block 345), then the HTTP header used to transmit a response message contains an embedded cookie with the case number. If using hidden fields (Block 350), the personalized page includes tags or other non-displayable elements that specify or otherwise refer to the case number. And finally, if using special URLs (Block 355), then either a special URL is returned as the response message to the user, or URLs embedded within a markup document to be transmitted to the user are modified to refer to the special URL(s). The response message containing the appropriate type of personalized Web page is then transmitted to the user (Block 360).

After transmitting a response to the user in Block 360, updates due to the user's on-going interactions with the WCI system are fed back to the server as subsequent request messages which use the same case number (or an identifiable variant thereof, as described earlier), thereby enabling more user-specific personalization as the user's navigation continues. Each subsequent request message during this on-going exchange is transmitted from the client, using the appropriate technique for communicating with the case number, and processed as described above (beginning with Block 305).

The interactions between the user and the WCI system and/or its service agent are preferably analyzed in real time (e.g. by a rules engine evaluating a stored rules base), and stored on the WCI server under the same case number. If shared browsing is being used, this information can also be used to generate personalized Web pages that are pushed (i.e. delivered) to the client to address the needs of different user experiences. A simple example is shown in FIG. 4. A Web page 400 is illustrated, which may be the first page displayed to the user as he begins interacting with this WCI system. In the absence of a user log-in, this page 400 will be relatively generic in content. A “new case” button 405 is shown, whereby the user in one embodiment explicitly indicates that he would like the WCI to assign a new case number to an upcoming series of message exchanges. A subsequent Web page 420 is shown, which in this example includes a title 425 that includes the case number. A special URL for this page may perhaps be generated (or otherwise retrieved) and pushed to the client, for example upon determining that this user has called or otherwise interacted with the WCI system some number of times (perhaps by comparing the number of incoming requests using the same case number to a threshold counter value) or upon determining that this user has encountered some particular experience while interacting with the WCI system.

In some embodiments, one or more special URLs are effectively “reserved” for one or more users of the WCI system. (Special URLs are preferably available for all users of a WCI system, although in particular cases it may be preferable to make this functionality available only to a subset of users.)

A special URL may be formed, for example, by using the user's name or perhaps the case number to identify a personalized Web page—or to identify the introductory Web page of a special navigation sequence. In this usage, Web page 420 may perhaps begin a navigation sequence that is not normally available to all users of the WCI system. Or, as another example, a special URL may be dynamically generated using a categorical approach, whereby the user's ongoing case history determines whether the user is shown a “VIP-level” page (as shown at 440 of FIG. 4) under particular circumstances, or perhaps a page directed to favored customers or even some classification of customers (such as those who may pay a premium for expedited or enhanced services). A myriad of different uses of special URLs may be envisaged once the teachings of the present invention are known.

Furthermore, the Web page displayed in response to activating a special URL may be personalized in any number of ways, according to the needs of a particular implementation of the present invention. For example, the page might have the user's name in it, or it might contain specific advertising banners or sales information if the WCI system determines that this user has been shopping for a birthday or anniversary gift. As another example, it may reflect the status of the user's case thus far. If instant messaging or e-mail is being used rather than shared browsing, then a special URL may be transmitted to the user using those means, allowing the user to continue browsing with his personalized Web page by activating the transmitted link (or, the user may perhaps continue browsing from his current page). When using shared browsing, then the special URL may be selected by the user, using a Web page that is pushed from the WCI system, or alternatively the service agent may activate the special URL thereby causing the personalized Web page to display on the user's computer.

As has been demonstrated, the present invention provides advantageous techniques for improving WCI systems. Using the disclosed techniques, related requests sent to the WCI system are automatically associated. This association may be used to automatically determine the appropriate personalized information to provide for the user, including but not limited to generating a special URL. In preferred embodiments, no changes are required on client devices or in client software. These advantages are achieved while enabling the user to remain anonymous (i.e. without requiring the user to log in or otherwise explicitly identify himself, without requiring the client to support cookies, and without requiring URL rewriting—and even though the IP address and/or port number of the client may change from one request to another. This technique for linking the user's computer to the back-end WCI system to deliver anonymous personalized content enables the user to obtain additional benefits from a WCI system without doing anything other than what he does today with a prior art WCI system, thus providing an unobtrusive means for obtaining an improved WCI system.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention also provides advantageous techniques for doing business, in which a user enjoys a more productive and enjoyable interaction with a WCI system, thereby increasing the value of such systems to sales and service organizations.

The present invention has been described with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While preferred embodiments of the present invention have been described, additional variations and modifications in those embodiments may occur to those skilled in the art once they learn of the basic inventive concepts. Therefore, it is intended that the appended claims shall be construed to include both the preferred embodiments and all such variations and modifications as fall within the spirit and scope of the invention.

What is claimed is:

1. A method of providing improved user interactions in a networking environment, comprising steps of:
assigning a unique case identifier to an interaction, wherein the interaction comprises transmission of a series of related messages;
annotating each of the related messages, except a first incoming one thereof, with information reflecting the assigned case identifier; and
transmitting at least one of the annotated messages to a user.

2. The method according to claim 1, wherein the case identifier is a case number.

3. The method according to claim 1, wherein the annotation step further comprises inserting the case identifier into a Uniform Resource Locator (“URL”) in an object requested by a selected one of the related messages, thereby creating an annotated object, and wherein the transmitting step further comprises transmitting the annotated object as the annotated message.

4. The method according to claim 3, wherein the case identifier is inserted as a parameter of the URL.

5. The method according to claim 3, wherein the case identifier is inserted within one of (1) a domain name portion of the URL or (2) a path name portion of the URL.

6. The method according to claim 1, further comprising the step of annotating selected objects referenced within a document that is to be transmitted as part of a selected annotated message.

7. The method according to claim 1, wherein at least one of the annotated messages is a response that serves a Web page to a computer of the user.

8. The method according to claim 1, wherein at least one of the annotated messages is a request for a Web page sent from a computer of the user.

9. The method according to claim 1, wherein at least one of the annotated messages is a response that serves a Web page to a computer of the user and wherein at least one subsequent one of the related messages is a request for information referenced by the Web page.

10. The method according to claim 1, wherein at least one of the annotated messages is a response that serves a Web page to a computer of the user and wherein at least one subsequent one of the related messages is a request for information selected from the Web page by the user.

11. The method according to claim 1, wherein the annotation step further comprises inserting one or more cookies into selected ones of the related messages, and wherein the transmitting step transmits the annotated message to a browser of the user.

12. The method according to claim 11, farther comprising the step of automatically returning the one or more cookies from the browser as the annotation of subsequent ones of the related messages sent by the browser.

13. The method according to claim 1, wherein the annotation step further comprises inserting one or more hidden fields into selected ones of the related messages, and wherein the transmitting step transmits the annotated message to a computer of the user.

14. The method according to claim 13, farther comprising the step of automatically returning the one or more hidden fields from the computer as the annotation of subsequent ones of the related messages sent by the computer.

15. The method according to claim 1, wherein the annotation step further comprises providing a special Uniform Resource Locator (“URL”) in at least one of the related messages.

16. The method according to claim 15, further comprising the step of sending a request for the special URL in at least one subsequent one of the related messages, wherein the special URL is automatically included as the annotation of the subsequent message after receiving the special URL in the transmitted annotated message.

17. The method according to claim 15, wherein the special URL identifies content that is personalized with information pertaining to the user.

18. The method according to claim 15, wherein the special URL identifies content that is personalized with information pertaining to a problem scenario of the user.

19. The method according to claim 15, wherein the special URL identifies content that is personalized with information pertaining to a navigational sequence of the user.

20. The method according to claim 1, further comprising the step of receiving a subsequent message from the user, wherein the subsequent message automatically contains the annotation from the transmitted message.

21. The method according to claim 1, further comprising the step of receiving a subsequent message from the user, wherein the subsequent message contains an identifiable variant of the annotation from the transmitted message.

22. A method of providing an improved user interaction system in a networking environment, comprising steps of:
assigning a case identifier to an interaction which comprises transmission of a series of related messages;
providing the assigned case identifier when transmitting each of the related messages that is directed to a user to which the interaction pertains; and
automatically returning the assigned case identifier on each of the related messages that is sent from the user, except a first incoming one thereof, thereby providing an on-going automatic association among the series of related messages.

23. A system for providing improved user interactions in a networking environment, comprising:
means for assigning a unique case identifier to an interaction, wherein the interaction comprises transmission of a series of related messages;
means for annotating each of the related messages, except a first incoming one thereof, with information reflecting the assigned case identifier; and
means for transmitting at least one of the annotated messages to a user.

24. The system according to claim 23, wherein the case identifier is a case number.

25. The system according to claim 23, wherein the means for annotating further comprises means for inserting the case identifier into a Uniform Resource Locator (“URL”) in an object requested by a selected one of the related messages, thereby creating an annotated object, and wherein the means for transmitting further comprises means for transmitting the annotated object as the annotated message.

26. The system according to claim 25, wherein the case identifier is inserted within a domain name portion of the URL

27. The system according to claim 25, wherein the case identifier is inserted within a path name portion of the URL.

28. The system according to claim 23, further comprising means for annotating selected objects referenced within a document that is to be transmitted as part of a selected annotated message.

29. The system according to claim 23, wherein at least one of the annotated messages is a response that serves a Web page to a computer of the user and wherein at least one subsequent one of the related messages is a request for information selected from the Web page by the user.

30. The system according to claim 23, wherein the means for annotating further comprises means for inserting one or more cookies into selected ones of the related messages, and wherein the means for transmitting transmits the annotated message to a browser of the user.

31. The system according to claim 30, further comprising means for automatically returning the one or more cookies from the browser as the annotation of subsequent ones of the related messages sent by the browser.

32. The system according to claim 23, wherein the means for annotating further comprises means for inserting one or more hidden fields into selected ones of the related messages, and wherein the means for transmitting transmits the annotated message to a computer of the user.

33. The system according to claim 32, further comprising means for automatically returning the one or more hidden fields from the computer as the annotation of subsequent ones of the related messages sent by the computer.

34. The system according to claim 23, wherein the means for annotating further comprises means for providing a special Uniform Resource Locator (“URL”) in at least one of the related messages.

35. The system according to claim 34, further comprising means for sending a request for the special URL in at least one subsequent one of the related messages, wherein the special URL is automatically included as the annotation of the subsequent message after receiving the special URL in the transmitted annotated message.

36. The system according to claim 34, wherein the special URL identifies content that is personalized with information pertaining to the, user.

37. The system according to claim 34, wherein the special URL identifies content that is personalized with information pertaining to a problem scenario of the user.

38. The system according to claim 23, further comprising means for receiving a subsequent message from the user, wherein the subsequent message automatically contains the annotation from the transmitted message.

39. The system according to claim 23, further comprising means for receiving a subsequent message from the user, wherein the subsequent message contains an identifiable variant of the annotation from the transmitted message.

40. A system for providing an improved user interaction system in a networking environment, comprising:
means for assigning a case identifier to an interaction which comprises transmission of a series of related messages;
means for providing the assigned case identifier when transmitting each of the related messages that is directed to a user to which the interaction pertains; and
means for automatically returning the assigned case identifier on each of the related messages that is sent from the user, except a first incoming one thereof, thereby providing an on-going automatic association among the series of related messages.

41. A computer program product for providing improved user interactions in a networking environment, comprising: p1 computer-readable program code means for assigning a unique case identifier to an interaction, wherein the interaction comprises transmission of a series of related messages;
computer-readable program code means for annotating each of the related messages, except a first incoming one thereof, with information reflecting the assigned case identifier; and
computer-readable program code means for transmitting at least one of the annotated messages to a user.

42. The computer program product according to claim 41, wherein the computer-readable program code means for annotating further comprises computer-readable program code means for inserting the case identifier into a Uniform Resource Locator (“URL”) in an object requested by a selected one of the related messages, thereby creating an annotated object, and wherein the computer-readable program code means for transmitting further comprises computer-readable program code means for transmitting the annotated object as the annotated message.

43. The computer program product according to claim 42, wherein the case identifier is inserted as a parameter of the URL.

44. The computer program product according to claim 42, wherein the case identifier is inserted within one of (1) a domain name portion of the URL or (2) a path name portion of the URL.

45. The computer program product according to claim 41, wherein at least one of the annotated messages is a response that serves a Web page to a computer of the user.

46. The computer program product according to claim 41, wherein at least one of the annotated messages is a request for a Web page sent from a computer of the user.

47. The computer program product according to claim 1, wherein at least one of the annotated messages is a response that serves a Web page to a computer of the user and wherein at least one subsequent one of the related messages is a request for information referenced by the Web page.

48. The computer program product according to claim 41, wherein the computer-readable program code means for annotating further comprises computer-readable program code means for inserting one or more cookies into selected ones of the related messages, and wherein the computer-readable program code means for transmitting further comprises computer-readable program code means for transmitting the annotated message to a browser of the user.

49. The computer program product according to claim 48, further comprising computer-readable program code means for automatically returning the one or more cookies from the browser as the annotation of subsequent ones of the related messages sent by the browser.

50. The computer program product according to claim 41, wherein the computer-readable program code means for annotating further comprises computer-readable program code means for inserting one or more hidden fields into selected ones of the related messages, and wherein the computer-readable program code means for transmitting transmits the annotated message to a computer of the user.

51. The computer program product according to claim 50, further comprising computer-readable program code means for automatically returning the one or more hidden fields from the computer as the annotation of subsequent ones of the related messages sent by the computer.

52. The computer program product according to claim 41, wherein the computer-readable program code means for annotating further comprises computer-readable program code means for providing a special Uniform Resource Locator (“URL”) in at least one of the related messages.

53. The computer program product according to claim 52, further comprising computer-readable program code means for sending a request for one of the related messages, wherein the special URL is automatically included as the annotation of the subsequent message after receiving the special URL in the transmitted annotated message.

54. The computer program product according to claim 52, wherein the special URL identifies content that is personalized with information pertaining to the user.

55. The computer program product according to claim 52, wherein the special URL identifies content that is personalized with information pertaining to a navigational sequence of the user.

56. The computer program product according to claim 41, further comprising computer-readable program code means for receiving a subsequent message from the user, wherein the subsequent message automatically contains the annotation from the transmitted message.

57. The computer program product according to claim 41, further comprising computer-readable program code means for receiving a subsequent message from the user, wherein the subsequent message contains an identifiable variant of the annotation from the transmitted message.

58. A computer program product of providing an improved user interaction system in a networking environment, comprising:
computer-readable program code means for assigning a case identifier to an interaction which comprises transmission of a series of related messages;
computer-readable program code means for providing the assigned case identifier when transmitting each of the related messages that is directed to a user to which the interaction pertains; and
computer-readable program code means for automatically returning the assigned case identifier on each of the related messages that is sent from the user, except a first incoming one thereof, thereby providing an on-going automatic association among the series of related messages.
